(19) United States
(12) Patent Application Publication
(10) Pub. No.: US 2012/0193305 A1
(43) Pub. Date: Aug. 2, 2012

(54) CONTINUOUS TREATMENT OF WATER CONTAINING CARBON BLACK

(75) Inventors: Karl-Heinz Jass, Luenen (DE); Daniel Oryan, Gelsenkirchen (DE); Andreas Alke, Dortmund (DE); Sascha Wenzel, Bochum (DE)

(73) Assignee: ThyssenKrupp Uhde GmbH, Dortmund (DE)

(21) Appl. No.: 13/386,289

(22) PCT Filed: Jul. 14, 2010
(86) PCT No.: PCT/EP2010/004274

§ 371 Date: Apr. 2, 2012

(30) Foreign Application Priority Data
Jul. 22, 2009 (DE) 10 2009 034 494.2

(51) Int. Cl. C02F 1/38; C02F 11/12; C02F 101/20

(52) U.S. Cl. 210/771; 494/37; 210/770

(57) ABSTRACT

Process for the continuous treatment of soot water which arises during partial oxidation of liquid hydrocarbons containing heavy metals. The soot water is centrifuged at a pressure of up to 5 bar and a temperature of up to 150° C. in a pre-dewatering stage, without the addition of additives, to 10% solids content, a pasty sludge rich in heavy metals is obtained and a centrate low in heavy metals arises. The centrate at least to some extent, is fed back into the gasification process again as useable water.

The invention relates to a process for the continuous treatment of soot water that arises from the partial oxidation of heavy-metal-containing liquid hydrocarbons.

A high-temperature process such as the partial oxidation of heavy-metal-containing liquid hydrocarbons generates dispersed soot that is predominantly discharged from the process by scrubbing the soot-containing raw gas with water. The soot water contains up to approximately 2% soot and this soot contains heavy metals, mainly nickel and vanadium.

After scrubbing, the soot water has a temperature of between 150° C. and 300° C. and a pressure of 40 to 85 bar. Generally, it is passed through a pressure-reducing device and a cooler in order to obtain soot water in an atmospheric state with an acceptable temperature so that it can be further treated. Although the soot water contains a high percentage of water, it has a highly viscous consistency and the soot hardly precipitates. Dewatering of the soot water is thus highly complex. In practice, the soot water is usually collected in tanks and later subjected to filtration. This is a batch process, the water separated off via the filtration being heated as process water and recycled to the process, with the remaining residues being deposited in tanks for further processing.

DE 40 03 242 A1 describes a process for separating soot from soot water in which the soot water is mixed with sludge at a sludge treatment plant, with a dewatering agent, such as organic flocculant, being added before the soot water undergoes filtration. This process requires large amounts of dewatering agents and a lot of space, which is a major economic burden.

DD 10 63 35 also describes a process for the treatment of soot water, in which a lime-containing suspension is added to cause sedimentation. In so doing, the soot water is subjected to a chemical process, meaning that the contaminated effluent cannot be recycled without further treatment.

Publication DE 4331322 A1 focuses on a process for separating unwanted materials from sludge at a sludge purification plant with settling basins and agitators. In the example application mention is made of the removal of soot and heavy metals downstream of a flue gas desulphurisation unit using a hydrocyclone for thickening. Due to the viscous, pasty quality of soot water arising from the partial oxidation of liquid hydrocarbons, hydrocyclones are unsuitable for use in the dewatering process.

The soot water can also be filtered off in batches. For this, large-volume stackable tanks are required upstream and downstream of the filtration unit; this, however, leads to higher costs than the continuous process.

Therefore, the invention is aimed at the problem of developing a process for the continuous treatment of soot water from the partial oxidation of heavy-metal-containing liquid hydrocarbons that is technically simpler and more economical from a cost point of view than the state of the art.

The invention achieves the objective via the following process for the continuous treatment of soot water that accumulates during the partial oxidation of heavy-metal-containing liquid hydrocarbons. In this process the soot water is drawn off from the gasification process at a temperature of 150° C. to 300° C. and a pressure of 40 to 85 bar, and passes through a pressure-reducing device to reduce the pressure to down to approximately 5 bar before it is centrifuged to a solids content of up to 10% at a pressure of up to 5 bar and a temperature of up to 150° C. in a pre-dewatering step with no agents being added, a pasty soot sludge rich in heavy metals being obtained and a centrate that is low in heavy metals accumulating. This centrate is recycled, at least in part, to the gasification process as process water.

The soot water from the partial oxidation of heavy-metal-containing liquid hydrocarbons has a temperature of 150° C. to 300° C. and a pressure of 40 to 85 bar. It must first pass through a pressure-reducing device to reduce the pressure of up to approximately 5 bar. The soot water is cooled to 150° C. by a cooler if the temperature of the soot water is over 150° C. The dewatering of the soot water is carried out in two steps. In a pre-dewatering step the soot water is passed through a centrifuge at a pressure of up to 5 bar and a temperature of up to 150° C. without adding any agents, a viscous soot sludge rich in heavy metals and a centrate low in heavy metals being obtained. The soot sludge contains up to 10% solids. The centrate, which has not been contaminated with any additives, is for the most part recycled to the gasification process as process water. Before the process water that is to be recycled flows back into the gasification process, it is heated to 150° C. if the temperature of the centrate is below 150° C. Due to the low temperature loss of the centrate during operation, the centrate also requires only slight reheating.

Some embodiments of the invention envisage the pre-dewatering being carried out using a sedimentation centrifuge, the sedimentation centrifuge being either a solid-bowl screw-type centrifuge or a disc centrifuge as these centrifuges can perform the dewatering of the soot water at a pressure of up to 5 bar and a temperature of up to 150° C.

In further embodiments of the invention the soot sludge, which is rich in heavy metals, is post-dewatered to a solids content of up to 20%. This is carried out using either continuously operated dewatering equipment, such as a belt filter press, or batchwise-operated dewatering equipment, such as a chamber filter press. The post-dewatering can also be carried out in a drying unit or a spray dryer. After pre-dewatering, the soot sludge can, of course, also be further dewatered in a multi-hearth furnace and subsequently incinerated.

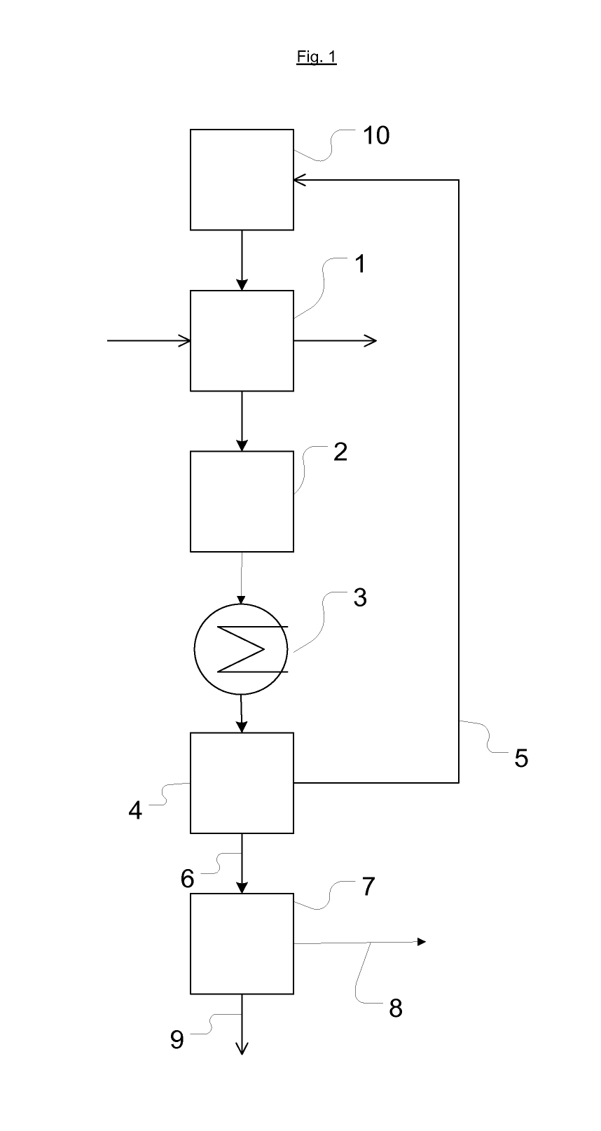

The invention is explained by means of FIG. 1. The pressure of the soot water accumulated by the scrubber (1) is first reduced from 40-85 bar to approximately 5 bar in a pressure-reducing device (2). If the temperature of the soot water is over 150° C., the soot water is cooled to approximately 150° C. in an air or water cooler (3). After being cooled, the soot water with a pressure of up to 5 bar and a temperature of up to 150° C. is pre-dewatered by a centrifuge (4), a pasty soot sludge rich in heavy metals (6) being obtained and a centrate that is low in heavy metals (5) accumulating. This centrate is recycled to the gasification process (10) as process water, the process water being heated to 150° C. if the temperature of the centrate is below 150° C. The soot sludge (6) is further dewatered to a solids content of up to 20% in a post-dewatering unit (7). Optionally, the post-dewatering (7) can be carried out using filtering agents. The water that is obtained (8) is forwarded for treatment. The filter cake (9) with a solids content of approximately 20% is compact, landfillable and available for further treatment.

The process in accordance with the invention is characterised in that the pre-dewatering can be carried out in a centrifuge in a fully mechanical way at a pressure of up to 5 bar and a temperature of up to 150° C. with no agents being added, the centrate obtained being heated only slightly and recycled to the gasification process as process water. This dispenses with the costs of additional agents and energy, greatly reduces the amount of water consumed in the process and obviates the need for tanks to collect the soot water, which is a major economic advantage over the state of the art. Pre- and post-dewatering can be carried out using simple dewatering equipment.

### LIST OF REFERENCE NUMBERS AND DESIGNATIONS

1 Scrubber

2 Pressure-reducing device

3 Cooler

4 Centrifuge

5 Centrate

6 Soot sludge

7 Post-dewatering unit

8 Water

9 Filter cake

10 Gasification process

1. Process for the continuous treatment of soot water that arises from the partial oxidation of heavy-metal-containing liquid hydrocarbons, comprising;
drawing off soot water from a gasification process at a temperature of 150° C. to 300° C. and a pressure of 40 to 85 bar,
passing soot water through a pressure-reducing device to reduce the pressure to down to approximately 5 bar before it is centrifuged to a solids content of up to 10% at a pressure of up to 5 bar and a temperature of up to 150° C. in a pre-dewatering step with no agents being added, a pasty soot sludge rich in heavy metals being obtained and a centrate that is low in heavy metals accumulation; and
recycling, the centrate at least in part, to the gasification process as process water.

2. Process according to claim 1, further comprising cooling the soot water to 150° C. by a cooler if the temperature of the soot water is above 150° C.

3. Process according to claim 1, further comprising heating the process water to be recycled to 150° C. if the temperature of the centrate is below 150° C.

4. Process according to claim 1, wherein the pre-dewatering is carried out with the aid of a sedimentation centrifuge.

5. Process according to claim 4, wherein the sedimentation centrifuge is either a solid-bowl screw-type centrifuge or a disc centrifuge.

6. Process according to claim 1, wherein the soot sludge, which is rich in heavy metals, is post-dewatered to a solids content of up to 20%.

7. Process according to claim 6, wherein the post-dewatering is carried out using continuously operated dewatering equipment.

8. Process according to claim 7, wherein the continuously operated dewatering equipment is a belt filter press.

9. Process according to claim 6, wherein the post-dewatering is carried out using batchwise-operated dewatering equipment.

10. Process according to claim 9, wherein the batchwise-operated dewatering equipment is a chamber filter press.

11. Process according to claim 6, wherein the post-dewatering is carried out in a drying unit.

12. Process according to claim 6, wherein the post-dewatering is carried out in a spray dryer.

13. Process according to claim 6, wherein the post-dewatering is carried out in a multi-hearth furnace with subsequent incineration taking place
